(19) United States
(12) Patent Application Publication
(10) Pub. No.: US 2022/0345784 A1
(43) Pub. Date: Oct. 27, 2022

(54) SYSTEM FOR EXCHANGING LOCAL AREA MESSAGES

(71) Applicant: Telegenic, Inc., Mercer Island, WA (US)

(72) Inventor: Sun Chang, Bellevue, WA (US)

(73) Assignee: Telegenic, Inc., Mercer Island, WA (US)

(21) Appl. No.: 17/858,054

(22) Filed: Jul. 5, 2022

Related U.S. Application Data
(63) Continuation-in-part of application No. 16/126,793, filed on Sep. 10, 2018, now Pat. No. 11,381,876.
Application No. 16/126,793 is a continuation-in-part of application No. 16/126,527, filed on Sep. 10, 2018, now Pat. No. 10,764,639.
Application No. 16/126,527 is a continuation-in-part of application No. 16/126,214, filed on Sep. 10, 2018, now abandoned.
(60) Provisional application No. 63/310,193, filed on Feb. 15, 2022.
(60) Provisional application No. 62/556,347, filed on Sep. 9, 2017.
(60) Provisional application No. 62/556,349, filed on Sep. 9, 2017.
(60) Provisional application No. 62/556,351, filed on Sep. 9, 2017.
(60) Provisional application No. 62/556,347, filed on Sep. 9, 2017.
(60) Provisional application No. 62/556,349, filed on Sep. 9, 2017.
(60) Provisional application No. 62/556,351, filed on Sep. 9, 2017.
(60) Provisional application No. 62/556,347, filed on Sep. 9, 2017.
(60) Provisional application No. 62/556,349, filed on Sep. 9, 2017.
(60) Provisional application No. 62/556,351, filed on Sep. 9, 2017.

(51) Int. Cl. H04N 21/4788; H04N 21/488

(52) U.S. Cl. CPC H04N 21/4788; H04N 21/4882

(57) ABSTRACT

A system for exchanging a number of local area messages includes a processor, system memory, a network interface card, and a non-transitory storage medium that are communicatively coupled. The non-transitory storage medium includes a first receiving subcomponent, a first sending subcomponent, a second receiving subcomponent, a second sending subcomponent, and a controlling subcomponent. The first receiving subcomponent receiving a first message from a first video device. The first sending subcomponent sends the first message to a second video device. The second receiving subcomponent receives a second message from the second video device. The second sending subcomponent sends the second message to the first video device. The controlling subcomponent controls the communication of the first message and the second message to monitor the identity of the user of the first video device and the second video device.

### CROSS-REFERENCE TO RELATED APPLICATIONS

The non-provisional form of this application will claim the benefit and incorporate by reference all of the patent applications and as well as any patents that are listed in the associated Application Data Sheet.

### TECHNICAL FIELD

The disclosure generally relates to a computer system for devices communicating in a network. More specifically, a system for exchanging messages in a network to coordinate interaction between a number of users of the system is disclosed.

### BACKGROUND

Travelers often end up in an unfamiliar location and seek to consolidate costs on activities. This may include traveling, meals, or group activities. Occasionally, activities may stress or overload supportive services around events.

### BRIEF SUMMARY

Embodiments of a system are disclosed; the system is for exchanging a number of local area messages and may have a processor, system memory coupled to the hardware processor, and a non-transitory storage medium. The system memory may store instructions that are executable by the processor. The non-transitory storage medium may store a number of subcomponents; each subcomponent comprising a processor and a number of instructions in stored on a non-transitory storage medium, may cause the computer system to perform a particular task. The non-transitory storage medium may include a first receiving subcomponent, a first sending subcomponent, a second receiving subcomponent, a second sending subcomponent, and a controlling subcomponent. The first receiving subcomponent may receive a first message from a first video device. The first sending subcomponent may send the first message to a second video device. The second receiving subcomponent may receive a second message from the second video device. The second sending subcomponent may send the second message to the first video device. The controlling subcomponent may control the communication of the first message and the second message to monitor the identity of the user of the first video device and the second video device.

A system for exchanging messages in a local area may include a message controlling device, a first device, and a second device. The message controlling device may include a processor, system memory coupled to the hardware processor, and a non-transitory storage medium. The system memory may store instructions that are executable by the processor. The non-transitory storage medium may store a number of subcomponent; each subcomponent, when executed by the processor, may cause the computer system to perform a particular task. The non-transitory storage medium may include a first receiving subcomponent, a first sending subcomponent, a second receiving subcomponent, a second sending subcomponent, and a controlling subcomponent. The first receiving subcomponent may receive a first message from a first messaging device. The first sending subcomponent may send the first message to a second messaging device. The second receiving subcomponent may receive a second message from the second messaging device. The second sending subcomponent may send the second message to the first messaging device. The controlling subcomponent may control the communication of the first message and the second message to monitor the identity of the user of the first messaging device and the user of the second messaging device. The first messaging device may be communicatively-connected to the message controlling device. The first messaging device may include a user input subcomponent and a network communication subcomponent. The user input subcomponent may receive the first message from a user of the first messaging device. The network communication subcomponent may communicate with the message controlling device. The second messaging device may be communicatively-connected to the message controlling device. The second messaging device may include a network communication subcomponent and a user output subcomponent. The network communication subcomponent may communicate with the message controlling device. The user output subcomponent may receive a message, such as a first message or a second message, from the message controlling device and may instruct the second messaging device to display the message.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, subcomponents, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph six, interpretation for that unit/circuit/component.

A subcomponent includes a processor communicatively-coupled to a non-transitory storage medium wherein a number of instructions that cause the subcomponent to perform a task are stored on the non-transitory storage medium. A number of sub-components may share a processor, varying the subcomponent based on the number of instructions executed by a processor.

The general descriptions of methods, computer systems, and computer program products of U.S. Pat. No. 9,053,243 are incorporated by reference. A computer program product and method claim are disclosed. The module is a number of processors coupled to a number of nontransitory storage mediums having stored instructions for performing a task: a module could be one processor and one non-transitory storage medium having stored instructions; a module may also be one processor coupled to two or more non-transitory storage mediums having stored instructions.

### BRIEF DESCRIPTION OF THE DRAWINGS

In order to describe the manner in which the above-recited and other advantages and features can be obtained, a more particular description will be rendered by reference to specific implementations thereof, which are illustrated in the appended drawings. These drawings depict only some implementations; the invention is not limited solely to what is depicted in the drawings; implementations will be described and explained with additional specificity and detail through the use of the accompanying drawings in which:

FIG. 1 illustrates an example of a system for exchanging messages in local area wherein the system is communicating with a number of video devices.

FIG. 2 illustrates an example of a local area message exchanger.

FIG. 3 illustrates an example of a local area message exchanger communicating with a number of video devices.

FIG. 4 illustrates an example of a local area message exchanger communicating with a number of video devices.

FIG. 5 illustrates an embodiment of a graphical user interface of some embodiments of a disclosed system to activate and operate a transparent overlay of information and UI controls on top of video that is being played through a TV media device.

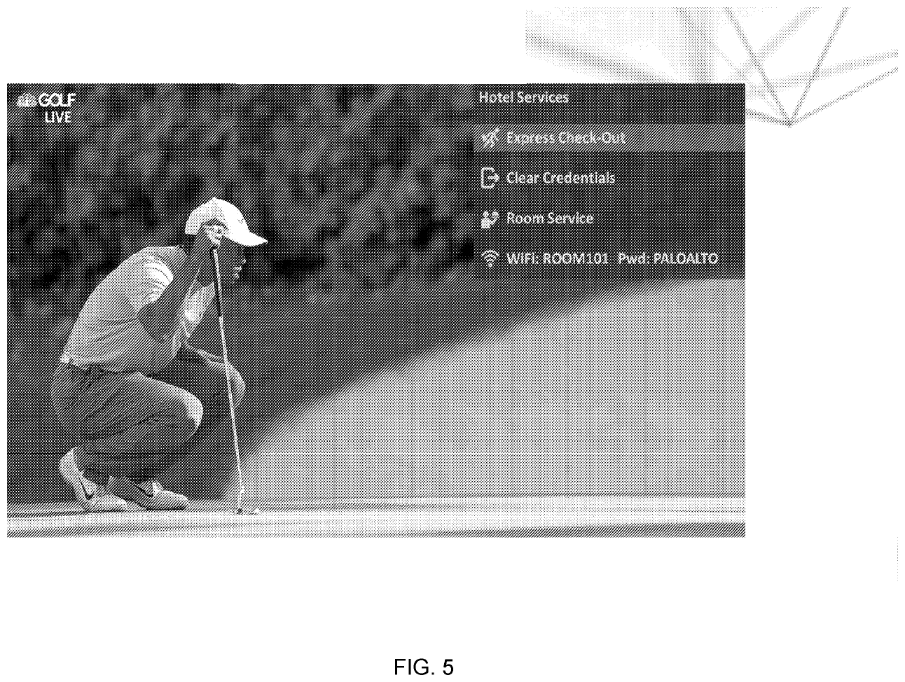

FIG. 6 illustrates an embodiment of a graphical user interface of some embodiments of a disclosed system to perform IoT functions through a TV media device with the disclosed embodiments of inventions.

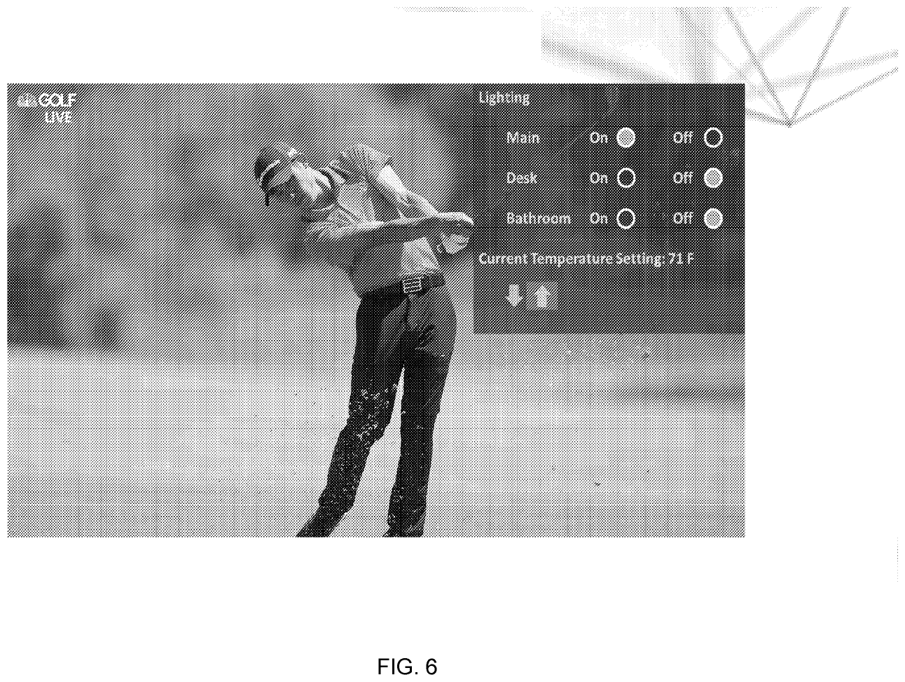

FIG. 7 illustrates an embodiment of a graphical user interface of some embodiments of a disclosed system to enable in-room messaging through a TV media device with the disclosed embodiments of inventions, which may further enable messaging between personal devices connected to the same LAN.

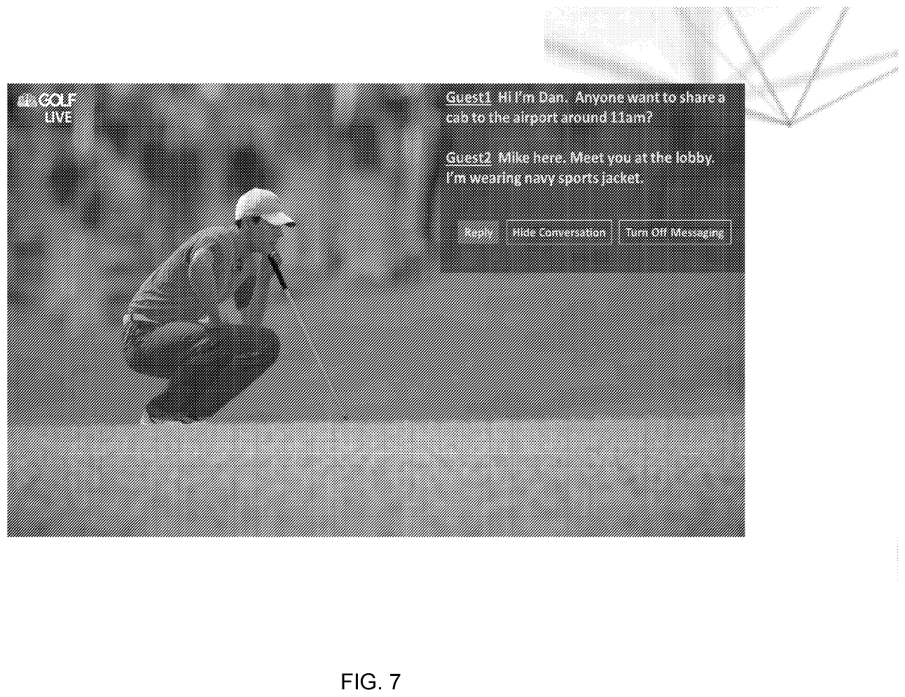

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations, without departing from the substance of the claimed invention. Thus, the detailed description of the examples in the figures is merely representative of a number of embodiments of the invention and is not intended to limit the scope of the invention as claimed.

In some instances, numerical values are used to describe features such as spreading factors, angle, trajectory, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

For purposes of this disclosure, “displaying” something on a device may also be deemed “instructing” the device to display something.

For purposes of this disclosure, local area message exchanger refers to a system for exchanging a number of a number of local area messages.

For purposes of this disclosure, a subcomponent refers to a combination of hardware and program instructions for performing a designated function. Each of the subcomponents may include a processor and memory. The program instructions may be stored in the memory and may cause the processor to execute the designated function of the subcomponents. Additionally, a smartphone app and a corresponding computer system may be used to implement a subcomponent or a combination of subcomponents. Additionally, a video device comprising a computer system or system as described in the claims may be used to implement a subcomponent or a combination of subcomponents. Additionally, a video device comprising a computer system or system as described in the claims may be used to implement a subcomponent or a combination of subcomponents. Additionally, a video device and a computer system or a system may be used to implement a subcomponent or a combination of subcomponents.

Examples extend to apparatus, devices, methods, systems, and computer program products for exchanging a number of local area messages. The present invention generally relates to systems and methods for exchanging messages between devices through a local area message exchanger. More specifically, the disclosed system relates to exchanging a number of local area messages between a number of users to facilitate the use of services that are available or that are made available.

As used in the present specification and in the appended claims, local area message refers to a message sent from one device to another device on the same LAN. A single LAN system can span across multiple buildings, such as within a college campus, a group of affiliated hotels in the same city, or an office park. An example of a local area message would be an invitation to dinner for all devices on the network.

As used in the present specification and in the appended claims, subcomponent refers to a combination of software and hardware that perform a particular task.

As used in the present specification, an “identifier” is a token that names a language entity; for example, restaurant identifier may be something that represents a restaurant. For example, “MCD-S19+J89” may represent the McDonald's restaurant that has geocoordinates “S19+J89” that may be recognizable by a mapping service such as Google Map. Another example of a restaurant identifier is MCD which may represent McDonald's, without information about the location of the specific McDonalds.

As used in the present specification and in the appended claims, video device refers to a computer that provides a video or replicated video interface to a user of the video device. A video device may include an input device.

As used in the present specification and the appended claims, services refer to services or products that may be desired or requested by users of the system.

As used herein “sending a message” may include sending a copy of the message.

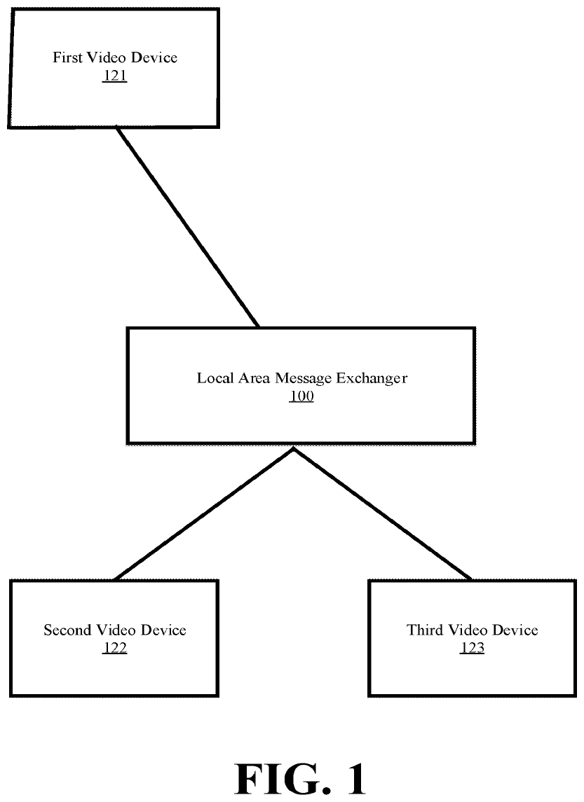

FIG. 1 illustrates an example of the system for exchanging a number of local area messages. In this example, the local area message exchanger (100) communicates messages between a first video device (121), a second video device (122), and a third video device (123). In some embodiments the local area message exchanger may communicate between two video devices or may communicate among a plurality of video devices. In some embodiments the local area message exchanger may broadcast a message to all of the video devices, or a subgroup of video devices, in a specified location, such as all of the video devices in a hotel, convention center, university, office building, or motel.

The local area message exchanger (100) may identify the first video device (121) and may identify user information associated with the user of the first video device (121).

The local area message exchanger (100) may identify that the message to be exchanged is for coordinating a rideshare to a local attraction, such as a convention, a train station, a bus station, an airport, or an amusement park. If two or more users of the local area message exchanger (100) desire or agree to coordinate a ride, they may reduce the cost of traveling to the venue as well as reducing traffic and pollutants, saving both money and environmental costs.

The first video device (121) may broadcast the message to the user of the second video device (122) and the user of the third video device (123).

In this example, the user of the second video device (122) may acknowledge the requester rideshare and accepts the offer for sharing the expense of the rideshare. The second video device (122) may receive a return message from the user of the second video device (122) and may send an acknowledgment to the first video device (121). The local area message exchanger (100) may communicate, such as via an API, the reservations of a number of services to a third party, such as Uber™, Lyft™, or other rideshare systems.

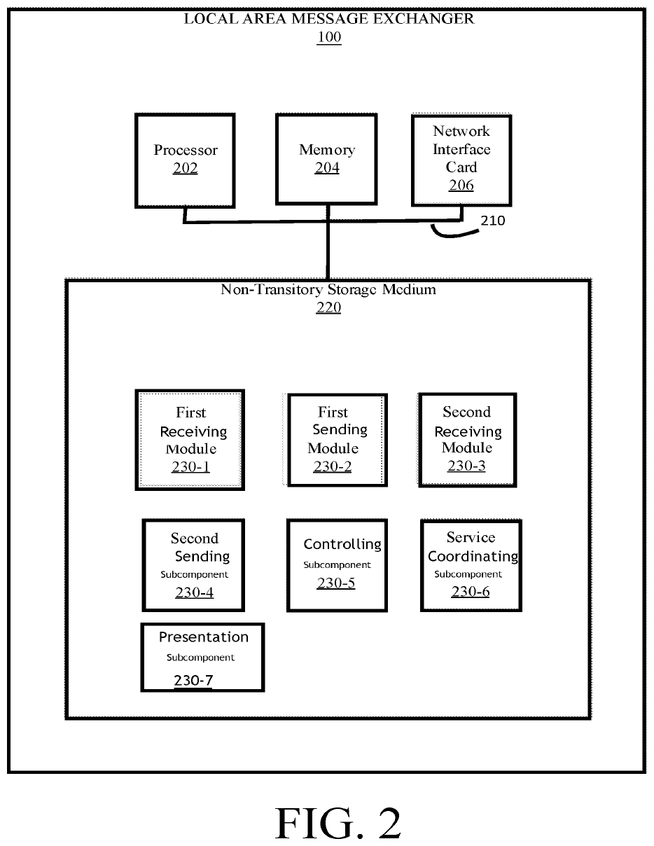

FIG. 2 illustrates a local area message exchanger (100), according to one example of the principles described herein. In this example, the local area message exchanger (100) may include a processor (202), memory (204), a network interface card (206), a communication bus (210), and a non-transitory storage medium (220). The non-transitory storage medium (220) may include a number of subcomponents; each subcomponent may cause the local area message exchanger (100) to perform a particular task. For purposes of this disclosure, a subcomponent refers to a combination of a processor communicatively coupled to a Subcomponent are a software instructions, stored on a non-transitory storage medium, communicatively-coupled by a processor to. Subcomponents may also comprise hardware communicatively coupled to software In this example, the non-transitory storage medium (220) includes a first receiving subcomponent (230-1), a first sending subcomponent (230-2), a second receiving subcomponent (230-3), a second sending subcomponent (230-4), a controlling subcomponent (230-5), and a service coordinating subcomponent (230-6).

The processor (202) executes instructions that may be stored in memory (204) or on the non-transitory storage medium (220) to cause the local area message exchanger (100) to perform a particular task.

The memory (204) may communicate with the processor (202) using a communication bus (210) to provide the processor with access to a working memory set.

The network interface card (206) may be communicatively-connected to the processor (202) such that the processor (202) may communicate with other devices over a network. The network interface card (206) may use a wired connection, or wireless connection. The network interface card may use a number of protocols such as the transmission control protocol/Internet protocol (TCP/IP), wireless communication protocols, or other networking protocols. An example of another networking protocol may include Bluetooth™ technology.

As illustrated, the non-transitory storage medium (220) may include a number of subcomponents. Each subcomponent may include hardware, software, or combinations thereof to perform a particular task. In this example, the non-transitory storage medium (220) includes a first receiving subcomponent (230-1), a first sending subcomponent (230-2), a second receiving subcomponent (230-3), a second sending subcomponent (230-4), a controlling subcomponent (230-5), and a service coordinating subcomponent (230-6).

The first receiving subcomponent (230-1) may receive a first message from a first video device (FIG. 1, 121). The first message may indicate a request from the first video device, seeking another user that wishes to share a service.

The first sending subcomponent (230-2) may send the first message, which herein may include sending a copy of the first message, to a number of other video devices, and in some embodiments the first sending subcomponent (230-2) may send a confirmation message to the first video device to confirm that the first sending subcomponent (230-2) has sent the first message. For example, local area message exchanger (100) may send the first message to the second video device (FIG. 1, 122), the third video device (FIG. 1, 123), or both the second video device (FIG. 1, 122) and the third video device (FIG. 1, 122). Local area message exchanger (100) may send a number of messages to a plurality of video devices; and in some embodiments, the video devices to which the local area message exchanger (100) sends a number of messages may be located in the same hotel, in a group, (such as the group of all video devices, of a consortium of hotels that are within a 5 mile, or other designated distance, radius, that are connected to the same network), in a geographical area define by a user, or a subset of a group (such as all of the video devices associated with a current customer who attended a recent sales convention at the local convention center (which may be determined by whether the customer of the hotel received a certain group discount available to attendees of that conference).

The second receiving subcomponent (230-3) may receive a second message, in response to the first message, from the second video device (FIG. 1, 122) and/or the third video device (FIG. 1, 123). The second receiving subcomponent (230-3) may receive a second message from the second video device and a third message from a third video device.

The local area message exchanger (100) may use a second sending subcomponent (230-4) to send the second message to the first video device (FIG. 1, 121). Alternatively, the local area message exchanger (100) may use the first sending subcomponent (230-2) to send the second message to the first video device (FIG. 1, 121).

The controlling subcomponent (230-5) may control the flow of the first message and second message being sent through the local area message exchanger (100). The controlling subcomponent (230-5) may filter messages to ensure that messages sent are appropriate for the environment in which they are being used. The controlling subcomponent (230-5) may send messages or delete messages after a critical time has expired. The controlling subcomponent (230-5) may log user information such that the operator of the local area message exchanger (100) can identify users that have used the local area message exchanger to coordinate services.

The local area message exchanger may include a service coordinating subcomponent (230-6) that may use the network interface card (206) to identify, praise, or facilitate services that may be coordinated by the local area message exchanger. In one example, the service coordinating subcomponent (230-6) may communicate over the Internet to a rideshare service, such as Uber™, to determine the availability of rides for users wanting to share service and the cost associated with reaching a particular destination.

An overall example according to FIG. 2 will now be given. The local area message exchanger (100) may be installed in conjunction with a hotel, motel, or other temporary residence facility.

A presentation subcomponent (230-7) may present a number of selections that may be used to form the first message on the first video device (FIG. 1, 121). The presentation subcomponent in this example indicates a number of restaurants that offer discounted meals for groups. The presentation subcomponent may coordinate the selection of an offer for a two for one meal.

The local area message exchanger (100) may receive a service share request from a first video device (FIG. 1, 121). The service share request may identify a user that wishes to take advantage of a local restaurant offering a two-for-one meal and wishes to share the advantage with another user of the local area message exchanger (100).

The local area message exchanger (100) may use the first receiving subcomponent (230-1) to receive the restaurant share request.

The controlling subcomponent (230-5) may process the first message identifying a user and a service selected by the user for coordination by the controlling subcomponent (230-5). The controlling subcomponent (230-5) may log information about the user of the first video device.

The local area message exchanger (100) may use a second receiving subcomponent (230-3) to receive a second message from the second video device (FIG. 1, 122) indicating an acceptance of the invitation by the user of the first video device (FIG. 1, 121).

The service coordinating subcomponent (230-6) may send a message over a computer network to a service provider indicating that the parties intend to use a service offered by the service provider. The service coordinating subcomponent (230-6) may also obtain or receive information regarding services available by a service provider including time, availability, price.

The second sending subcomponent (230-4) may send the second message from the second video device (FIG. 1, 122) to the first video device (FIG. 1, 121), confirming to the user of the first video device (FIG. 1, 121) of the acceptance of the offer. The second message may include identification information pertaining to the user of the second video device (FIG. 1, 122).

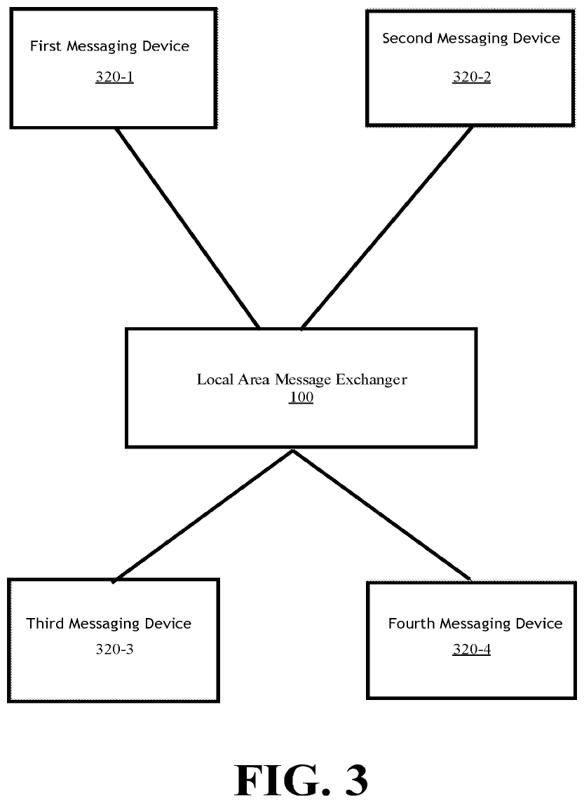

FIG. 3 illustrates a system for exchanging messages in a local area, according to one example of the principles described herein. The system comprises a local area message exchanger (100), and a number of messaging devices (320). The number of messaging devices may be communicatively connected to the local area message exchanger (100).

An overall example according to FIG. 3 will now be given. A first messaging device (320-1) initiates the sending of a first message to identify a ridesharing companion to a venue, such as a popularly frequented location. In the preferred embodiment, the location of the venue is close to the point of presence of the local area message exchanger (100). “Close to the point of presence” may be less than 10 miles, may be less than 50 miles, may be less than 100 miles, or may be a distance that may be traveled within 24 hours by car that is traveling 60 mph. The local area message exchanger (100) may cause the first message to be broadcast to the other devices on a local area network or on the same local area network. In this example, the first message may be sent to the second messaging device (320-2), a third messaging device (320-3) and a fourth messaging device (320-4).

A user of the third messaging device (320-3) may accept, via the third video device, via a computer connected to the local area message exchanger (100), or via a smartphone connected to the local area message exchanger (100), the invitation sent by the user of the first messaging device (320-1). The acceptance by the user of the third messaging device (320-3) causes a second message to be sent to the local area message exchanger (100) that is communicated to the first messaging device (320-1). The local area message exchanger (100) may coordinate a number of details to facilitate the service being shared by the user the first messaging device (320-1) and the user of the third messaging device (320-3).

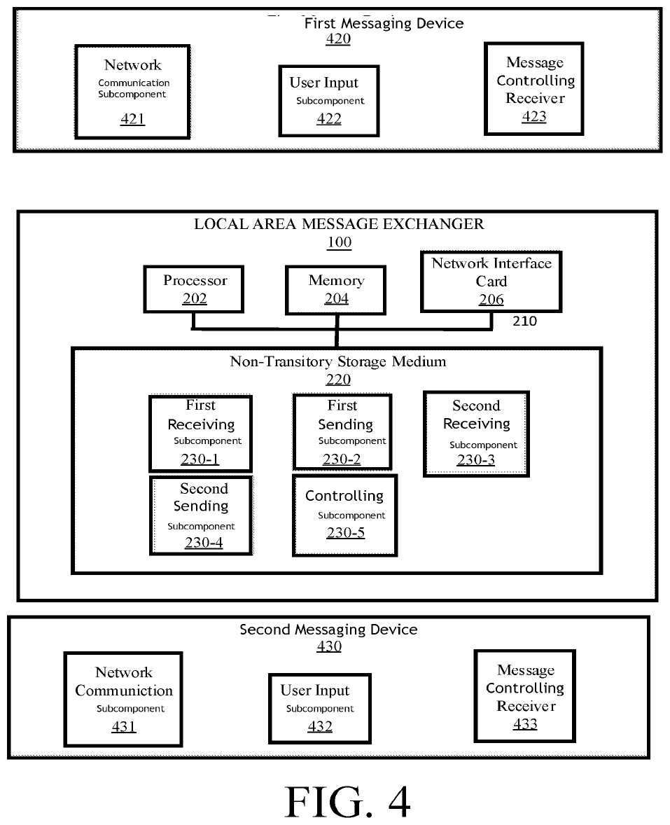

FIG. 4 represents a system for exchanging messages in the local area, according to one example of the principles described herein. The system includes a local area message exchanger (100), a first messaging device (420), and a second messaging device (430).

The local area message exchanger (100) may include a processor (202), memory (204) a network interface card (206), and a non-transitory storage medium (220) connected by a communication bus (210).

The processor (202) may be implemented as a combination of hardware and/or software. The processor (202) may execute a number of instructions that cause the local area message exchanger to execute instructions to perform a particular task.

The memory (204) may be random-access memory that provides storage of instructions and data to be accessed by the processor (202). The processor (202) may cause instructions to be moved from the non-transitory storage medium (220) across a communication bus (210) into memory for access by the processor (202).

The processor (202) may use the network interface card (206) to communicate with the first messaging device (420) and the second messaging device (430). The processor (202) may communicate with the network interface card (206) using the communication bus (210).

The non-transitory storage medium (220) may include a number of subcomponents (230). In this example, the non-transitory storage medium (220) includes a first receiving subcomponent (230-1), a first sending subcomponent (230-2), a second receiving subcomponent (230-3), a second sending subcomponent (230-4), and a controlling subcomponent (230-5).

The first receiving subcomponent (230-1) may receive a first message from the first messaging device (420).

The first sending subcomponent (230-2) may send the first message received from the first messaging device (420) to the second messaging device (430).

The second receiving subcomponent (230-3) may receive a second message from the second messaging device (430). The second message may be in response to the first message that was sent to the second messaging device (430).

The second sending subcomponent (430-4) sends the second message from the local area message exchanger (100) to the first messaging device (420).

The controlling subcomponent (230-5) controls the communication of the first message in the second message to monitor the identity of the user of the first messaging device and the second messaging device.

The first messaging device (420) includes a network communication subcomponent (421), user input subcomponent (422), and a message controlling receiver (423).

The network communication subcomponent (421) provides communication between the first messaging device (420) and the local area message exchanger (100).

The user input subcomponent (422) receives a first message from a user of the first messaging device (420).

The message controlling receiver (423) receives control messages from the local area message exchanger (100) and displaying the message on the first messaging device (4230).

The first messaging device (420) may include a data receive subcomponent to receive message data for the inclusion in a selected message. The data receive subcomponent may include data such as the time and destination to be included in a selected message. The data receive subcomponent may include a time and restaurant to be included in the selected message.

The second messaging device (430) includes a network communication subcomponent (431), a user output subcomponent (432), and a message controlling receiver (433).

The network communication subcomponent (431) provides network communication between the second messaging device (430) in the local area message exchanger (100).

The user output subcomponent (432) provides output for the first message received by the second messaging device (430). The first message may include control data sent from the local area message exchanger (100) to the message controlling receiver (433). The second messaging device (430) may format a message both for aesthetics and to provide the user of the second messaging device with a number of selectable options that may be made in response to the first message received from the first messaging device (420).

An overall example according to FIG. 4 will now be given. The local area message exchanger (100) through the controlling subcomponent (230-5) sends data to the first messaging device (420) indicating a particular message format allowing for the sharing of transportation to a nearby destination. The first messaging device (420) and receives the data with the data receive subcomponent to include information in a selected message.

The first messaging device (420) displays a message selection interface allowing a user to indicate a desired time to share a ride to a nearby destination. The user enters the desired time share ride to nearby destination.

The first messaging device (420) receives a first message from a user using the user input subcomponent (422). The first messaging device (420) sends the first message to the local area message exchanger (100) to the network communication subcomponent (421).

The local area message exchanger (100) receives the first message with the first rut message receive subcomponent (230-1). The controlling subcomponent (230-5) identifies the first message and the first messaging device (420) authenticating the user of the first messaging device to ensure that the user of the first messaging device is known and recorded. The controlling subcomponent (230-5) controls of the message sent from the first messaging device (420) adheres to message standards for the local area message exchanger (100).

The local area message exchanger (100) sends the first message using the first sending subcomponent (230-2) to the second messaging device (430).

The second messaging device receives the first message using the network communication subcomponent (431). The second messaging device may include a message receive subcomponent to receive the first message. The second messaging device may also include a user output subcomponent, to present the first message to a user of the second messaging device (430).

The first message may be monitored and controlled by the message controlling receiver (433). The message controlling receiver (433) may also receive formatting data and predetermined options to respond to the first message received.

The second messaging device (430) includes a user input subcomponent (4320) to receive the input of these are the second messaging device (430) in responding to the first message. The input received on the second messaging device is used to create a second message to be sent to the local area message exchanger (100).

The second message is sent to the local area message exchanger (100) using the network communication subcomponent (431).

The local area message exchanger (100) receives the second message using the second receiving subcomponent (230-3). The controlling subcomponent (230-5) controls the second message to ensure the second message adheres to community standards and that the user of the second messaging device (430) is a known user to the local area message exchanger. The controlling subcomponent (230-5) may log the user of the second messaging device (430) along with the second message to provide security for users of the local area message exchanger (100).

The local area message exchanger (100) sends the second message to the first messaging device (420) using the second sending subcomponent (230-4).

The second message is then displayed on the first messaging device (420) so that the user of the first messaging device (420) is able to confirm that the offer has been accepted by the user of the second messaging device (430).

In other examples, instead of communicating a rideshare option, other common services may be communicated, such as sharing a meal at a restaurant.

The local area message exchanger (100) may communicate with other services to provide current discounts for users of the local area message exchanger (100) at local attractions, services, or other destinations.

Implementations may comprise or utilize a special purpose or general-purpose computer including computer hardware, such as, for example, one or more computer and/or hardware processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components.

A “network” is defined as one or more data links that enable the transport of electronic data between computer systems and/or subcomponents and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface subcomponent (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program subcomponents may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. In another example, computer code is configured for execution in one or more processors, and may include hardware logic/electrical circuitry controlled by the computer code. These example devices are provided herein for the purpose of illustration and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

The various components depicted in described computer architectures can be connected to (or be part of) a network, such as, for example, a system bus, a Local Area Network (“LAN”), a Wide Area Network (“WAN”), and even the Internet. Accordingly, the various components as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In some aspects, a computer system comprises one or more hardware processors and system memory. The one or more hardware processors execute instructions stored in the system memory to automatically perform any of the described functionality. In other aspects, computer implemented methods can be used to perform any of the described functionality. In further aspects, computer program products include computer-executable instructions, that when executed at a processor, cause a computer system to perform any of the described functionality.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

In one example, A set-top box in a hotel guest room, when acted on by the guest, sends a message to other set-top boxes in occupied rooms. This may be a 1-to-many broadcast.

The other set-top boxes may be identified in a database that resides on a server in the server room

The database may be integrated with the hotels' PMS (property management system) so it sets a flag, per room, whether the room is occupied or not

The other set-top boxes receiving the “broadcast” will throw a notification, with the message from the above guest, on the TV screen for its guest to see, even while a movie or tv show is playing.

The guests receiving the notification can either choose to participate in that “conversation” or discard it; the guests can also choose to turn off in-room messaging entirely.

When a guest checks out, which we know through the PMS integration, the guest's preferences are to be erased from that room's set-top box.

When guests choose to participate in a “conversation”, it starts a many-to-many messaging dialogue, aka “group chat session”

A chat session is destroyed when all participants choose to no longer participate in the conversation. The originator also may choose to kill a conversation that he/she started.

A guest responding to a notification may request a 1-1 conversation, if the originator agrees, then a 1-1 chat session will start, making their conversation invisible to other guests

Guests' personal information, e.g. name, room number, etc. will not be visible anywhere in the user interface. They will be identified as Guest1 through Guest N, N being the total number of participants in a conversation.

Embodiments of the invention may assist with a “taxi share” scenario where we may want to use a mobile app or integrate with a mobile device so that you can be in the lobby or anywhere else in the building where you are not in front of the TV. It may only function within a building through its local area network.

The system may be communicatively-coupled to software stored on an nontransitory storage medium of a mobile device, such as smartphone or tablet. The very first time that the “first send subcomponent” sends anything, it will be broadcasted to all devices within the local area network, not just to one specific “second video device”. E.g. the user in one room will send a message such as “who wants to share a ride to the airport” and it will be broadcasted to all other rooms. When someone wants to participate, he/she can have a 1:1 messaging with the person who initiated the original broadcast.

What is claimed:

1. A system for exchanging a number of local area messages, the system comprising:
a processor;
system memory coupled to the hardware processor, the system memory storing instructions that are executable by the processor;
a non-transitory storage medium, the non-transitory storage medium storing a number of subcomponents, each subcomponent, when executed by the processor, causes the system to perform a particular task, the non-transitory storage medium comprising:
a first receiving subcomponent operable for receiving a first message from a first video device controlled by a user of the first video device;
a first sending subcomponent, the first sending subcomponent operable for sending the first message to a second video device controlled by a user of the second video device;
a second receiving subcomponent, the second receiving subcomponent operable for receiving a second message from the second video device;
a second sending subcomponent, the second operable for sending the second message to the first video device;
a controlling subcomponent, the controlling subcomponent operable for controlling the communication flow of the first message and the second message and for monitoring the identity of the user of the first video device and the user of the second video device.

2. The system of claim 1, further comprising a presentation subcomponent, the presentation subcomponent operable for presenting a number of selections operable for forming the first message on the first video device.

3. The system of claim 2, wherein the presentation subcomponent further comprises receiving coordination data as part of the number of selections.

4. The system of claim 1, wherein the first video device and the second video device comprise electronic devices associated with a number of televisions.

5. The system of claim 1 further comprising a number of connections, via a local area network, to the first video device and the second video device a number of local area messages.

6. The system of claim 1, further comprising a service coordinating subcomponent, the service coordinating subcomponent operable for coordinating services available to the user of the first video device and the user of the second video device.

7. The system of claim 6, wherein the service coordinating subcomponent is operable for communicating with a number of third party systems to identify services available to users of the system.

8. The system of claim 6, wherein the service coordinating subcomponent is operable for coordinating transportation services.

9. The system of claim 6, wherein the service coordinating subcomponent is operable for coordinating, via a calendar of events, transportation services.

10. The system of claim 1, wherein the second sending subcomponent is operable for sending to a plurality of devices at least one selected from the group consisting of a first message, a second message, a first message and a second message, and a plurality of messages.

11. A system for exchanging messages in a local area network, the system comprising:
a message controlling device, the message controlling device comprising:
a processor;
system memory coupled to the hardware processor, the system memory storing instructions executable by the processor;
a non-transitory storage medium, the non-transitory storage medium storing a number of subcomponents, each subcomponent, when executed by the processor, causes the computer system to perform a particular task, the non-transitory storage medium comprising:
a first receiving subcomponent operable for receiving a first message from a first messaging device;
a first sending subcomponent operable for sending the first message to a second messaging device;
a second receiving subcomponent operable for receiving a second message from the second messaging device;
a second sending operable for sending the second message to the first messaging device;
a controlling subcomponent operable for controlling the communication of the first message and the second message to monitor the identity of the user of the first messaging device and the second messaging device;
a first messaging device, the first messaging device being communicatively-connected to the message controlling device, the first messaging device comprising:
a user input subcomponent, the user input subcomponent operable for receiving the first message from a user of the first messaging device;
a network communication subcomponent, the network communication subcomponent operable for communicating with the message controlling device;
a second messaging device, the second messaging device being communicatively connected to the message controlling device, the second messaging device comprising:
a network communication subcomponent, the network communication subcomponent operable for communicating with the message controlling device;
a user output subcomponent, the user output subcomponent operable for receiving a second message from the message controlling device and displaying the second message on the second messaging device.

12. The system of claim 11, wherein the first messaging device further comprises a message controlling subcomponent, the message controlling subcomponent being operable for receiving a number of control messages from the local area message exchanger and being operable to instruct the first messaging device to display the number of control messages on the first messaging device.

13. The system of claim 12, wherein the second messaging device further comprises a message controlling subcomponent, the message controlling subcomponent operable for receiving a number of control messages from the local area message exchanger and operable for displaying the number of control messages on the second messaging device.

14. The system of claim 13, wherein the local area message exchanger operable for presenting a number of formatted messages on the first messaging device selectable by a user of the first messaging device.

15. The system of claim 14, the first messaging device further including a data receiving subcomponent, the data receiving subcomponent being operable for receiving an amount of message data for inclusion in a selected message.

16. The system of claim 15, wherein the data receive subcomponent receives the amount of message data, the amount of message data comprising a time identifier and a destination identifier includable in the selected message.

17. The system of claim 16, wherein the amount of message data, received by the data receiving subcomponent, further comprises a time identifier and a restaurant identifier includable in the selected message.

18. The system of claim 17, wherein the data sending and receiving subcomponents as well as the video display component are implemented within a mobile device such as smartphone or tablet.
